(19) United States
(12) Patent Application Publication
(10) Pub. No.: US 2005/0048455 A1
(43) Pub. Date: Mar. 3, 2005

(54) Auscultation training device

(75) Inventors: Satoru Hayamizu, Gifu-shi (JP); Haruhisa Kawasaki, Gifu-shi (JP); Fumio Nogata, Gifu-shi (JP)

Correspondence Address: APEX JURIS, PLLC, 13194 EDGEWATER LANE NORTHEAST, SEATTLE, WA, 98125, US

(73) Assignee: Gifu University, Gifu-shi (JP)

(21) Appl. No.: 10/702,338

(22) Filed: Nov. 6, 2003

(30) Foreign Application Priority Data
Aug. 28, 2003 (JP) 2003-305261

(51) Int. Cl. G09B 23/28

(52) U.S. Cl. 434/262

(57) ABSTRACT

The auscultation training device enables a trainee to experience and learn various case studies without feeling the difference from the actual auscultatory action using the actual stethoscope in order to obtain the auscultatory technique. The auscultation training device 1 mainly comprises the model human body 4, which is an imitation of a human body upper torso; the stethoscope simulator 2 that the trainee 5 uses to perform the simulation of the auscultatory action on the model human body 4; an auscultatory sensor 8 which detects the auscultatory action by the trainee 5 with the stethoscope simulator 2; and the controller 3 which is connected to the stethoscope simulator 2 and the auscultatory sensor 8 respectively, whereby the controller receives the detected signals 9 of the auscultatory action transmitted from the auscultatory sensor 8, and then controls and processes signals for reproduction of vital sounds including those such as cardiac sounds and breathing sounds of the human body by a vital sound player 11 installed in ear piece 10 of the stethoscope simulator 2.

### FIELD OF THE INVENTION

This invention relates to an auscultation training device and particularly relates to an auscultation training device for student trainees studying at medical educational institutions such as medical schools. The invention is designed for the trainees to learn and to improve auscultation technique with a stethoscope thereby teaching the trainee to diagnose the symptoms of disease from vital sounds, such as cardiac sounds and breathing sounds, of a human body.

### BACKGROUND OF THE INVENTION

Traditionally, in medical institutions such as hospitals, doctors have utilized the stethoscope to diagnose and to grasp the symptoms of patients. The stethoscope has a diaphragm which directly contacts a body surface of the patient and a vibrating diaphragm with a vibrating surface which receives minute vital sounds, such as the cardiac sounds and the breathing sounds, which enables the trainee to hear and experience the vital sounds. Vital sounds as used hereout means either a single sound or plural sounds. The stethoscope has an ear piece that fits in each ear hole of the trainee through a Y-shaped rubber tube where each branched end is jointed to the ear piece while the other end is jointed to the diaphragm. As such, the stethoscope amplifies the vital sounds to enable auditory perception of the minute vital sounds which may not be heard without the help of the stethoscope. Accordingly, a person such as a doctor utilizing the stethoscope is able to diagnose and identify the particular symptoms or the affected part of the patient such as by hearing the vital sounds of the person without the interface of outside, physical handicaps or of undesired noise that mixes with the vital sounds causing aberrated vital sounds.

Stethoscope technique does not require the use of large scale medical equipment or a large medical facility and thus, allows the doctor to utilize the stethoscope in a relatively simple manner. Also, the use of the stethoscope gives the patient no or extremely small physical burden, thereby offering non-invasive diagnostic technology. Therefore, stethoscope diagnosis is prone to be utilized at an initial diagnostic step together with the use of palpation in order to diagnose an ambulatory patient for internal medicine and an inpatient for round. In addition, a person utilizing the stethoscope, such as a doctor and a nurse, generally hangs the stethoscope from his/her neck and carries it around during work, and therefore the stethoscope is one of the most well-known medical instruments.

However, accurate and prompt diagnosis of symptoms of the patient with the stethoscope may be difficult for a medical student or a doctor without sufficient skill and experience, and attaining and obtaining excellent stethoscope technique requires practice and experience. For example, medical professionals often come across symptoms of the common cold and asthma during the normal course of medical practice. Therefore, the medical professional is able to gain sufficient experience and practice on the symptoms of the common cold and asthma and therefore becomes capable of performing accurate diagnosis.

On the other hand, the medical professional rarely comes across a case where he/she, with the stethoscope, hears the heart of the patient with a problem in a specific cardiovascular system, and such a case is limited to the medical professional involved in cardio surgery. Therefore, medical professionals not in the cardio surgery field and medical students or trainees are not able to experience and learn stethoscope technology with respect to that symptom.

Of course, medical education institutions such as medical schools provide opportunities to learn or practice fundamental stethoscope techniques. However, the institution had difficulties in offering sufficient opportunities to provide training diagnosing actual patients of various cases with the stethoscope because of various reasons, such as time constraints and privacy problems.

Accordingly, simulators, for example as disclosed in the Japanese Patent Publication No. 5-27113 and the Japanese Provisional Patent Publication No. 2002-139991, have been developed in response to the demands for a simulator allowing the trainees, such as the medical students, to have virtual stethoscope training of various cases in order to gain sufficient stethoscope techniques. These conventional simulators employ a mannequin, mainly made of urethane, which comprises speakers embedded therein where the speakers reproduce vital sounds, such as the cardiac sounds, based on external electric signals transmitted from outside of the mannequin. Furthermore, the conventional simulators disclose a concave sound reflector positioned outside of the speaker embedded in the model body so that the simulated vital sounds similar or almost identical to the actual vital sounds can be reproduced at the auscultation point as if using the stethoscope or that an auscultatable range can be adjust depending upon the symptoms and palpation point.

Following problems exist in the above-disclosed conventional stethoscope technology with the stethoscope simulator having the speakers embedded in the mannequin. There, the speakers are embedded in predetermined positions of the mannequin, and as such the types of reproducible vital sounds from this type of speakers are very limited. Furthermore, because the vital sounds are reproduced by the speakers, the reproduced vital sounds are somewhat different from what is perceived by the actual stethoscope, thereby causing the trainee to hear non-lifelike peculiar sounds. Also, the reproduced vital sounds from the speakers do not offer variations of the vital sounds depending upon the particular auscultatory action. Auscultatory action takes several things into consideration, such as the auscultatory pressure and manner of contacting the stethoscope with the body, and therefore using the conventional type speakers is less effective for educational purposes.

Accordingly, although the trainee is able to learn about an approximate position on the human body from which the vital sounds can be heard, there are cases where the trainee receives a different impression, e.g., tone quality, between the reproduced vital sounds and the actual vital sounds with the stethoscope. Therefore, there is a strong demand for an auscultation training device that allows for variation of the reproduced vital sounds depending upon the stethoscope technique used, and for a training device that makes reproduced vital sounds that sounds as close to the actual vital sounds that might be heard during the actual auscultatory action.

This invention is made in response to the above cited demands and is to provide the auscultation training device that enables the trainee to practice and learn the stethoscope technique using the stethoscope simulator under conditions that are particularly close to the actual auscultatory action and that are capable of varying the reproduced vital sounds corresponding to the auscultatory action to be directly transmitted to the auditory perception of the trainee.

### SUMMARY OF THE INVENTION

In order to resolve the above-identified problems, this invention provides an auscultation training device, comprising: a model human body which is an imitation of a real human body; a stethoscope simulator which has at least one ear piece fitable in an ear hole of a trainee and an auscultatory section to be placed on the model human body for performing an auscultatory action; a vital sound data memory system which stores the data based on various vital sounds such as breath sounds and cardiac sounds generated from the human body; an auscultatory point locator which recognizes the auscultatory action on the model human body with the stethoscope simulator and determines a location of where the auscultatory action took place; a vital sound data extracting device which extracts the vital sound data from the vital sound memory, the vital sound data corresponds to the determined auscultatory point; and a vital sound playing device installed in the ear piece of the stethoscope simulator that reproduces the vital sound data extracted from the vital sound memory system.

The model human body means a model of a human body comprising applicable sections of the human body subject to the auscultatory action and, for example, may be a model of an entire human body or a model of an upper torso of the human body. Generally, the auscultatory action is performed on the chest region, abdominal region, and back region, and therefore the model preferably is the upper torso of the human body.

Furthermore, the stethoscope simulator is designed to duplicate the stethoscope appearance as used in the actual auscultation by the medical professional in the medical institution. The general structure of the stethoscope comprises the auscultatory section with a plastic auscultatory surface which directly contacts the body of the patient; a Y-shaped rubber tube mainly composed of the first tube section jointed with the auscultatory section and the second and third tube sections branched and extending from the first tube section; metal tubes jointed to and extending from the second and third rubber tube sections; and ear pieces jointed to the metal tube ends to be fitted in the ear holes of the medical professional. The vital sounds, such as the cardiac sounds, vibrate the auscultatory surface of the auscultatory section which amplifies the minute vital sounds and enables the trainee to hear the sound via the ear pieces.

The auscultation point locator detects and determines a contact point between the auscultatory section of the stethoscope simulator and the model human body, while the trainee is performing the auscultatory action on a surface of the model human body, and achieves the desired result by using a publicly known sensor. For example, a pressure sensor may be a surface contact type which covers over the model surface or is embedded in the body so as to detect the pressure applied onto the model surface for the purpose of locating/determining the auscultatory action. The auscultation point locator may be the sensor such as the above-described pressure sensor which is installed in the model human body or a three coordinate measuring device which can locate the auscultatory section by three-dimensionally measuring displacement of X-axis, Y-axis, and Z-axis based on a fundamental point. Furthermore, the vital sound player may be structured such that a sound reproducer is placed in the headphone which is then embedded in the ear piece of the stethoscope simulator.

Therefore, the auscultation training device of this invention, using the stethoscope simulator, can provide opportunities for the trainee to perform the simulated auscultatory action very similar to the actual auscultatory action. The auscultation point locator can locate the auscultatory point on the model surface of the model human body in response to the auscultatory action. The vital sound player extracts and compiles the vital sound data corresponding to the located auscultatory point from the vital sound data stored in the vital sound memory and then reproduces the vital sound data in an auditory, life like, replicated manner to the trainee via the ear pieces of the stethoscope simulator. When the auscultatory point is located adjacent to the heart of the model human body, the auscultation point locator locates the location of the heart, and the vital sound extractor extracts the vital sound data including the cardiac sounds from the vital sound memory to reproduce the cardiac sounds.

However, when the auscultatory section is placed on the model surface adjacent to the respiratory system, such as a lung, which is situated a slight distance away from the heart of the model human body, the vital sound extractor extracts the vital sound data corresponding to the breathing sounds created as the lung inhales and exhales. When the auscultatory section is placed on the model surface subject where no, or almost no vital sounds are generated, such as adjacent to a shoulder or the waist, the vital sound player does not reproduce any vital sound and goes into a silent state.

As such, the vital sounds corresponding to various locations on the model human body may be reproduced and heard from the ear pieces of the stethoscope simulator. Therefore, the trainee practicing the auscultatory technique can hear and experience the vital sounds similar to or nearly the same as the actual vital sounds of a live human body by operating the stethoscope simulator. That is, the trainee does not feel the difference between the actual and simulated auscultatory actions, which enables the trainee to learn the auscultatory technique promptly and effectively. Also, the trainee can promptly diagnose patient symptoms when he or she has to perform actual diagnosis. Additionally, the reproducible vital sounds also includes sounds that the medical professional may rarely comes across, e.g., the vital sounds of the case of heat disease, and therefore the trainee can experience many virtual sounds corresponding to various cases.

In addition to the above features, this invention still provides the auscultation training device further comprising: an auscultatory pressure detector which detects auscultatory pressure with the auscultatory section at the auscultation point determined by the auscultation point locator; and a vital sound variation device which based on the detected auscultatory pressure, varies at least one of a sound pressure characteristic and a frequency characteristic of the vital sound data subject to reproduction.

The auscultatory pressure detector detects the degree of the pressure applied on the model human body when the auscultatory action takes place and the auscultatory section of the stethoscope simulator contacts the model surface of the model human body, and the auscultatory pressure detector may be a piezo sensor generating electricity in response to the pressure applied, which may be an application of a semiconductor pressure sensor and a pressure sensitive polymer.

Accordingly, the auscultation training device of this invention can detect the auscultatory pressure simultaneous with the determination of the auscultatory point of the auscultatory action on the model surface. Generally, the vital sounds coming from the ear piece of the stethoscope varies depending upon the degree of pressure of the stethoscope applied to the body of the patient. For instance, when the auscultatory pressure on the model surface is extremely light or when the auscultatory section is slightly contacting the model surface with almost no pressure on the model surface, the acting medical professional will hardly hear the vital sounds. The auscultation training device of this invention is designed to reproduce this problematic situation such that the vital sound variation device controls the volume of the reproduced vital sound data to be low.

If appropriate auscultatory pressure is applied on the model surface, the vital sound variation device controls the volume of the reproduction of the vital sound data to be the same as the volume when using the actual stethoscope. Furthermore, if the auscultatory pressure force applied on the model surface exceeds a predetermined value, the vital sound variation device may find the auscultatory action as an inappropriate action and the control will then not reproduce the vital sound data. Accordingly, the trainee can learn and attain the proper technique of using the stethoscope. The sensors, such as a piezo sensor, for the detection of the auscultatory pressure, can functionally be shared with the pressure sensor acting as the above-described auscultation point locator. These sensors may cover the entire model surface, they can be embedded in the model human body, or alternatively, they can be installed in the auscultatory section of the stethoscope simulator for the detection of the auscultatory pressure.

In addition to the above features, this invention still provides the auscultation training device further comprising: a condition recognition device which recognizes a contact condition between a surface of the model human body and the auscultatory section during the auscultatory action; and a condition-vital sound variation device which, based on recognized contact condition therebetween, varies at least one of the sound pressure characteristic and the frequency characteristic of the vital sound data subject to reproduction.

Accordingly, the auscultation training device of this invention can recognize the condition of the contact between the auscultatory section of the stethoscope simulator and the surface of the model human body. If the contact between the auscultatory section and the surface of the model human body is insufficient, i.e., when the auscultatory surface of the auscultatory section is not sufficiently contacting with the model surface, or if any portion of the auscultatory surface inclines and fails to contact the model surface, this invention is so designed that the trainee is unable to hear the vital sounds appropriately just like when the trainee is utilizing the actual stethoscope. Recognizing and judging the condition of contact between the auscultatory section and the model surface allows for evaluation of the auscultatory technique regarding the contact, and varying the vital sound data subject to reproduction replicates and presents the condition to the trainee. Accordingly, the trainee can learn the appropriate auscultatory technique for that contact so that the proper vital sounds are reproduced.

In addition to the above features, this invention still provides the auscultation training device, wherein the vital sound memory system stores the vital sound data classified by gender, age, cases, and symptoms of the cases and has a reproduction prerequisite configuring device which presets reproduction prerequisites for the reproduction of the vital sound data.

Accordingly, the auscultation training device of this invention has the vital sound memory data pre-loaded, which is classified by gender, age, ailment, situational case, and the degree of progress in the case, subject to reproduction of the vital sounds. The trainee can select the prerequisites for reproduction of the stored vital sound data suitable for learning a particular symptom. For example, the auscultatory technique used for the vital sounds of the same condition may differ case by case, depending on the age, gender, etc. of the patient, and the trainee is able to learn the difference in the vital sounds when the patient is pyknic type or leptosomatic type. As a result, the trainee can hear and learn to recognize the vital sounds in various cases and conditions and as a result can have many experiences and can learn the auscultatory techniques.

In addition to the above features, this invention still provides the auscultation training device, wherein said vital sound data is based on vital sounds which are generated from said real human body.

Accordingly, the auscultation training device of this invention can utilize the actual vital sounds recorded therein for the basis of the vital sound data. As such, the trainee can learn the auscultatory technique during the performance of the auscultatory action that is very similar to or approximately the same as the actual auscultatory action. Also, the trainee can distinguish the patient symptoms while using and hearing the actual vital sounds. The vital sound data, which is to be varied by the above-described vital sound variation device or condition-vital sound variation device, is a composite tone characterized in that sound pressure thereof is modified based on the actual vital sound data and so on.

In addition to the above features, this invention yet provides the auscultation training device further comprising plural vital sound hearing means which enables at least two persons to hear said vital sound data reproduced therefrom.

Therefore, the auscultation training device of this invention can provide opportunities for more than one trainee to hear and experience the vital sound data, reproduced corresponding to the auscultatory action, with plural hearing devices. Plural hearing devices may be plural stethoscope simulators that have the same functions as the stethoscope simulator that the trainee uses to perform the auscultatory action. Therefore, the auscultation training device of this invention can provide opportunities for other persons, such as instructors and classmates, to hear the vital sound data reproduced corresponding to the auscultatory action of one trainee in real time. As a result the instruction and teaching of the instructor becomes more effective, and improved teaching efficiency can be expected.

It is an advantage of this invention to enable the trainee to experience and learn the auscultatory action without any discomforting feeling by performing the same auscultatory action as the actual auscultatory action with the stethoscope. Furthermore, vital sounds that medical professionals rarely encounter may be heard “virtually” based on the vital sound data. Therefore, the number and types of case data stored is not limited like it is in the conventional devices.

### BRIEF DESCRIPTION OF DRAWINGS

The present invention will now be described, by way of example, with reference to the accompanying drawings, in which:

FIG. 1 is a schematic view of the auscultation training device of this invention;

FIG. 2 is a schematic view of the stethoscope simulator of the auscultation training device of this invention;

FIG. 3 is a block diagram explaining the functional structure of the controller of the auscultation training device of this invention;

FIG. 4 is a view explaining one example of the auscultation action using the auscultation training device of this invention; and

FIG. 5 is a flowchart explaining the process of controlling the auscultation training device of this invention.

### DESCRIPTION OF THE PREFERRED EMBODIMENTS

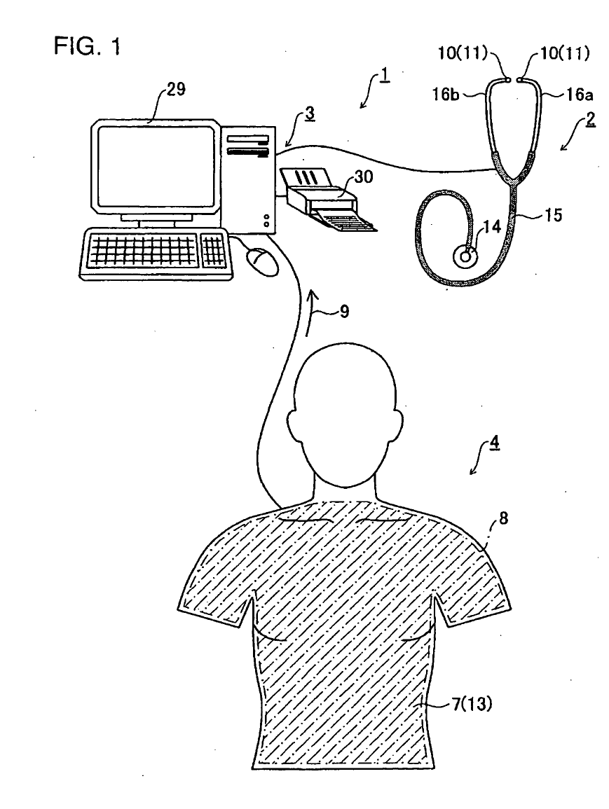

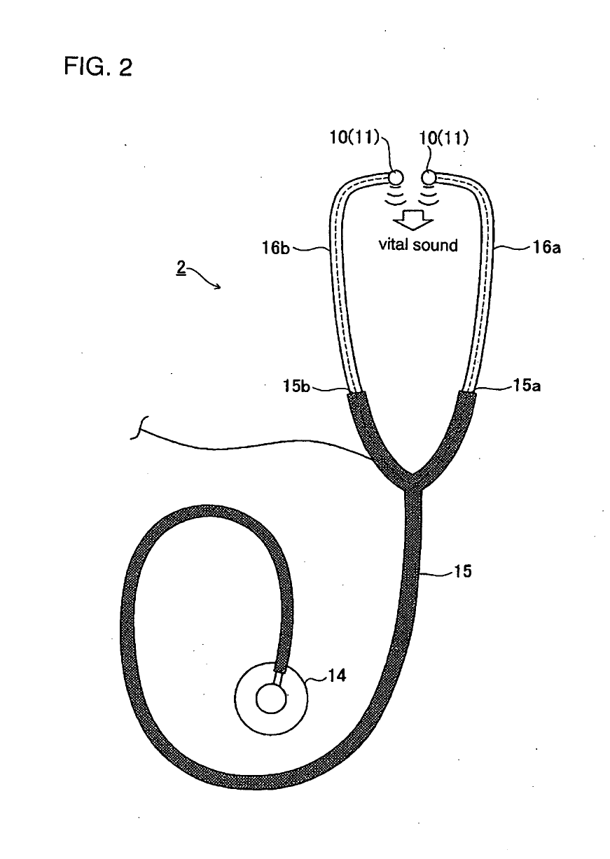

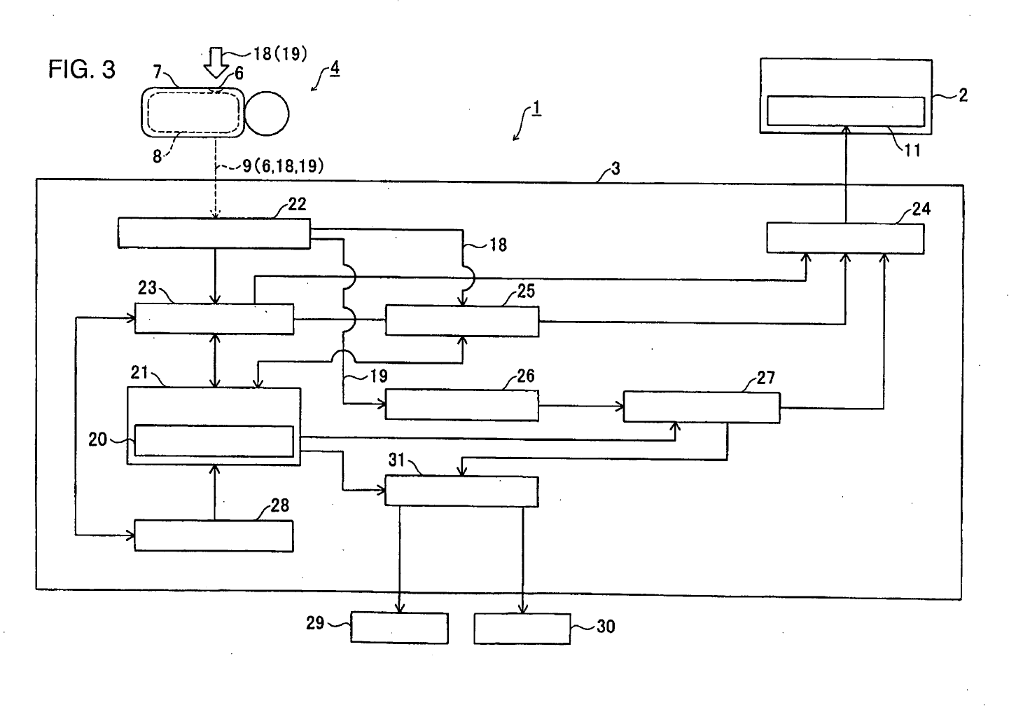

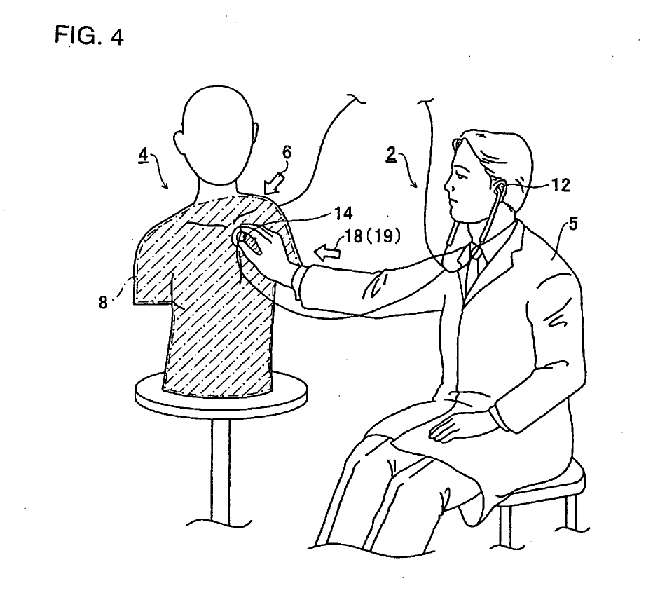

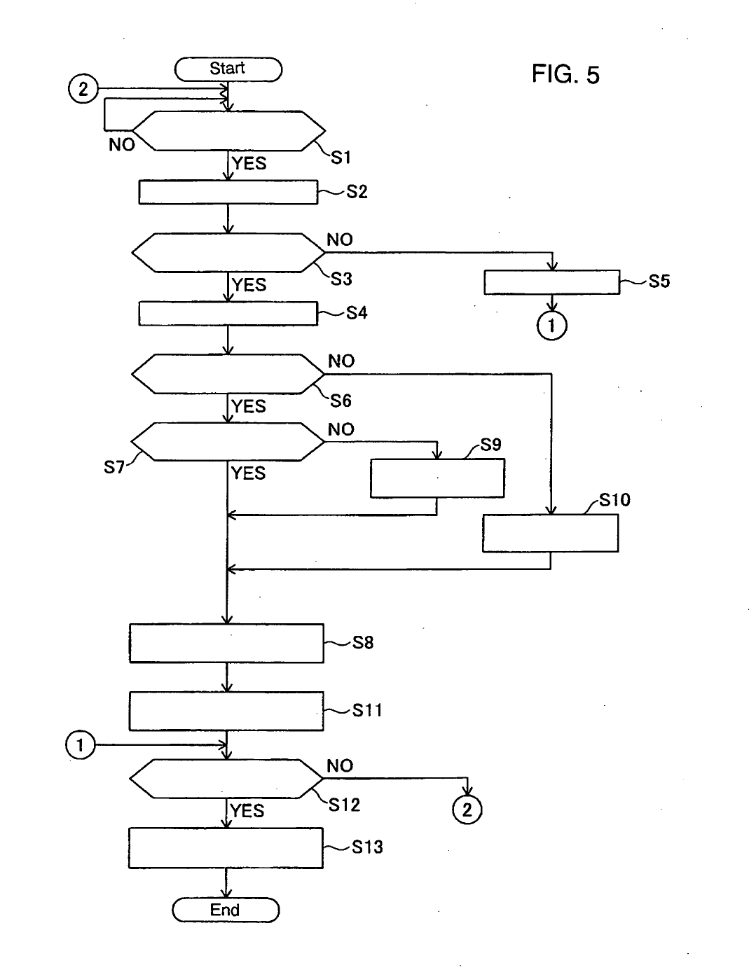

A first example of an auscultation training device 1 in this invention will be explained with reference to FIGS. 1-5. FIG. 1 illustrates a schematic structural diagram typically explaining one embodiment of the auscultation training device 1; FIG. 2 is a view explaining an appearance structure of the stethoscope simulator 2 of the auscultation training device 1; FIG. 3 is a block diagram mainly explaining the functional structure of the controller 3 of the auscultation training device 1; FIG. 4 is a view explaining one example of an operating state of the auscultation training device 1; and FIG. 5 is a flowchart explaining the process of the controller 3 in the auscultation training device 1.

As shown in FIGS. 1-4, the auscultation training device 1 of this embodiment mainly comprises a model human body 4 which is an imitation of the upper torso of a human body; a stethoscope simulator 2 that a trainee 5 uses to perform simulation of an auscultatory action on the model human body 4; an auscultatory sensor 8, which detects the auscultatory action by the trainee with the stethoscope simulator 2, is embedded in the model human body 4 throughout an entire model surface 7; and a controller 3 which is connected to the stethoscope simulator 2 and the auscultatory sensor 8 respectively, where controller 3 receives the detected signals of the auscultatory action transmitted from the auscultatory sensor 8 and controls and processes signals for reproduction of vital sounds. The sounds include those such as cardiac sounds or breathing sounds of the human body reproduced by a vital sound playing section 11 installed in an ear piece 10 of the stethoscope simulator 2. The vital sound playing section 11 in the ear piece 10 is equivalent to a vital sound player of this invention.

Furthermore, in more detail, an artificial skin 13 that feels like actual human skin covers the model surface 7 of the model human body 4, and, unlike plastic or wooden skin, this artificial skin 13 feels and responds the same as actual human skin while the trainee 5 is performing the auscultatory action on the model human body 4.

As shown in FIG. 2, the stethoscope simulator 2 is designed to duplicate the appearance of the stethoscope used in the actual auscultatory action by the medical professional in the medical institution, which mainly comprises the auscultatory section 14 having the auscultatory surface (not shown in FIG. 2) to be placed on and contacted with the model surface 7 of the model human body 4; a Y-shaped rubber tube 15 extending from the auscultatory section 14 and branched out into two separated tube ends 15a, 15b; metal tubes 16a, 16b jointed to the tube ends 15a, 15b respectively and extending in the opposite direction of the auscultatory section 14; and ear pieces 10, 10 installed at the ends of the metal tubes 16a, 16b and fitting in ear holes 12, 12 of the trainee 5. The stethoscope simulator 2 may be a partially modified actual stethoscope.

Further, the auscultatory sensor 8 employs plural surface contact type pressure sensors so as to detect the contact thereof on the entire model surface 7 of the model human body 4. In the case using the above-described auscultatory section 14 of the stethoscope 2 to contact with the model surface 7, the auscultatory sensor 8 is capable of detecting the contact position (auscultatory point 6), the pressure (auscultatory pressure 18) applied on an appropriate position of the auscultatory point 6, and the pressure distribution 19 of the auscultatory pressure 18 at the auscultatory point 6. The pressure distribution 19 allows the trainee to understand the contact condition between the auscultatory section 14 and the model surface 7. The detected signals 9, that includes information regarding the above-described auscultatory point 6 detected by the auscultatory action, is transmitted to the controller 3. Here, the auscultatory sensor 8 is equivalent to the auscultatory point locator, the auscultatory pressure detector, and the condition recognitioner.

The controller 3 is a main component of the auscultation training device 1 in this embodiment, which is capable of controlling and processing various signals according to the detected signals 9 transmitted from the auscultatory sensor 8 and further is capable of reproducing the desired vital sounds from the vital sound player 11 installed in the ear piece 10 of the stethoscope simulator 2. As shown in FIG. 3, the controller 3 has, as its functional components, the vital sound memory 21 wherein the vital sound data 20 subject to reproduction by the vital sound player 11 are stored with different classification by gender, age, case history, symptom, and the auscultatory position 6; an interface 22 which receives the detected signals 9 including information regarding such as the auscultatory position 6 detected by the auscultatory sensor 8; the vital sound extractor which analyzes the detected signals 9 received at the interface 22 and extracts the vital sound data 20 from the vital sound memory 21; and a reproduction controller 24 which controls signals for reproduction of the extracted vital sound data 20 at the vital sound player 11 installed in the ear piece 10 of the stethoscope simulator 2. As shown in FIG. 1, a publicly available personal computer may be used for the controller 3, and input devices such as a keyboard and a mouse may be utilized to perform various types of operations and data entry. Here, the vital sound memory 21 is equivalent to the vital sound memory section of this invention, and the vital sound extractor 23 is equivalent to the vital sound extracting section of this invention.

Furthermore, the controller 3 comprises the auscultatory pressure controller 25 which varies the sound pressure and the frequency characteristics of the vital sound data 20 which is reproduced in correspondence to the auscultatory pressure 18 detected by the auscultatory sensor 8; the condition recognitioner 26 which recognizes the contact condition of the auscultatory section 14 of the stethoscope simulator 2 in correspondence to the pressure distribution 19; and the evaluation controller 27 which evaluates the contact condition of the recognized auscultatory section 14 and varies the sound pressure and the frequency characteristics of the vital sound data 20 subject to reproduction. Furthermore, the controller 3 further comprises the reproduction prerequisite configurator 28 which allows the trainee 5 to select various reproduction prerequisites to be selected such as particular cases and symptoms based on the vital sound data 20 stored in the above described vital sound memory 21. Here, the auscultatory pressure controller 25 is equivalent to the vital sound variation device of this invention; the condition recognitioner 26 is equivalent to the condition-vital sound variation device of this invention; and the reproduction prerequisite configurator 28 is equivalent to the reproduction prerequisite configuring device. Furthermore, the controller 3 has an output controller 31 which makes the evaluation results from the evaluation controller 27, and other various information, visually recognizable by controlling and outputting the signals to an output device, such as a monitor 29 and/or a printer 30.

In the auscultation training device 1 of this embodiment, the vital sound data 20 stored in the vital sound memory 21 utilizes actual vital sounds from patients displaying various symptoms and which were observed and recorded using microphones or other sourcing device. In addition, controlling the modifications of the vital sound data 20 according to the above-described reproduction prerequisite and the auscultatory action is based on actual vital sounds collected in actual cases. As such, the vital sound data 20 subject to reproduction is closer to the actual vital sounds received with the stethoscope during the actual auscultation, thereby minimizing the possibility of giving discomfort feeling about the sound authenticity. As a result, this invention can provide a very practical education regarding the auscultation technique.

As an example, if the auscultatory section 14, a portion of the stethoscope simulator 2, contacts the chest region of the model body 4, the vital sound data 20 extracted corresponds to the breathing sounds generated by the respiratory organs such as the lungs and the bronchus, but if the auscultatory section 14 contacts the left chest of the model human body 4, the vital sound data 20 extracted corresponds to the cardiac sounds. Then, a more accurate and detail extraction of the vital sound data 20, suitable for auscultatory point 6, is possible and can be adjusted.

For instance, the auscultatory point 6 is around the respiratory organ, the vital sounds that could possibly be generated can broadly be divided into the following categories:
(a) tracheal sound—which can be heard around an extrathoracal upper trachea and is characterized by deep, high articulation with approximately equal lengths of inhalation and exhalation components;
(b) bronchial breath sound—which can be heard around an upper episternum; resembles the sounds of air passing through a vent pipe and is characterized by a deeper and longer inhalation than exhalation components;
(c) bronchial vesicular breathing—which can be heard between the first and second intercostals of the precordial region and between the shoulder blades and is the mixed sounds of the bronchial breathing sounds and vesicular murmur; and
(d) vesicular murmur—which can be heard mostly around the upper chest wall portion contacting a normal peripheral lung and may be a soft low articulation. The above-described are typical categories.

On the other hand, various types exist for the case for an abnormal and diseased respiratory organ, and examples are as follows:
(a) rhonchi wheeze—which is typically generated when contraction occurs at a portion of the respiratory tract, thereby increasing the air flow speed and finally generating a vibration due to the co-action of the respiratory tract walls
(b) intermittent tone/crackle—which is short discontinuous crackle such as fine crackle (crepitation) typically heard in diffuse interstitial pneumonia having inflammation of alveolus septum as a typical symptom or rough intermittent tone (bubbling rale) typically heard in bronchiectasis, pneumonitis, chronic bronchitis, complicated infection of pulmonary emphysema, cardiac decompensation, and advanced lung edema; and
(c) extrapulmonary abnormal breathing sound (pleural friction rub), etc. The above-described are the examples. The auscultation training device 1 of this embodiment stores the vital sounds of both normal states and abnormal states, which may be heard from the above-mentioned respiratory organs, as the vital sound data 20. The auscultation training device 1 uses the data as the reproducing condition configurator 28 to change/vary the vital sound data 20 subject to reproduction as appropriate. Regardless of the vital sounds of the respiratory organs, cardiac sound and murmur relative to the cardiac sound or murmur of the vascular flow within the blood vessel may be reproduced.

One example of the training of the auscultatory technique utilizing auscultation training device 1 of this embodiment will be explained mainly with reference to FIGS. 3-5. Explanation of FIG. 4 is omitted here to simplify the entire description, and the structure/components of the controller 3 of the auscultation training device 1 of this embodiment is abbreviated herein.

To begin with, the trainee 5 wears the stethoscope simulator 2 just like using an actual stethoscope during normal diagnosis. That is, the trainee 5 inserts a pair of ear pieces 10, 10 at the ends of the stethoscope simulator 2 in the ear holes 12, 12 and hangs the metal tubes 16a, 16b jointed to the ear pieces 10, 10, the Y-shaped rubber tube 15, and the auscultatory section 14 from the ears. A pair of metal tubes 16a, 16b of the stethoscope simulator 2, just like the normal stethoscope, are designed to urge toward each other while the trainee 5 is wearing the simulator 2, which holds the head of the trainee 5 therebetween with slight pressure, thereby maintaining the position of the stethoscope simulator 2. The trainee 5, for example, holds hanging auscultatory section 14 with a thumb, a forefinger, and a middle finger so as to prepare for the auscultatory action. At or during any of the above steps of setting the stethoscope simulator 2 on the trainee 5 a power source for the entire device (especially controller 3) is turned on to activate the auscultation training device 1 of this embodiment.

The trainee 5 or an instructor, such as a professor of the medical school who teaches auscultation, uses the input device to operate the controller 3 to set the reproduction prerequisites for the vital sound data 20 to be reproduced. The preset reproduction prerequisite here, for example, is that the patient is a male of about 30 years old with an abnormal, asthmatic condition in the respiratory organs and that the auscultation training device is capable of reproducing the asthmatic symptom. Additionally, the patient's other organs are in a normal state, and as thus, the cardiac sound is reproduced as a healthy cardiac sound.

The trainee 5 auscultates by holding the auscultatory section 14 and placing a portion thereof (the auscultatory surface) on the auscultatory point 6 of the model surface 7 in the model human body 4 subject to the auscultation. During the above-auscultatory action of the trainee 5, the auscultatory sensor 8 embedded in the model surface 7 of the model human body 4 detects the auscultatory action. After the auscultatory sensor 8 detects the auscultatory action, the auscultatory sensor determines the position (auscultatory point) on the model surface 7 of the model human body 4 contacting the auscultatory surface of the auscultatory section 14 and measures the auscultatory pressure 18 at the auscultatory point 6 and the pressure distribution 19. Then, the detected signals 9, including the detected information regarding the auscultatory point 6, the auscultatory pressure 18, and the pressure distribution 19, are transmitted to the controller 3.

The controller 3 determines whether or not the detected signals 9 were transmitted (S1). If the detected signals 9 were found to be transmitted at S1, the controller 3 receives the detected signals 9 via an interface 22 (S2) and proceeds with the later described steps, such as extracting the vital data 20 based on information involved in the detected signals 9.

However, if the detected signals 9 were found not to be transmitted at S1, the controller 3 continues the process of S1 and waits for the detected signals 9 to be transmitted from the auscultatory sensor 8 due to the auscultatory action of the stethoscope simulator 2.

Then, the controller 3, after receiving the detected signals 9, attends to extract the vital sound data 20 corresponding to the auscultatory point 6 from the vital sound player 11 of the ear piece 10. Here, the information of the auscultatory action relating to auscultatory point 6, included in the detected signals 9, is examined and if the vital sound data 20, corresponding to the auscultatory point 6 (for example, the first and second intercostals of a precordial region) is found to be YES at S3, the vital sound data 20 is extracted from the vital sound memory 21. As such, the vital sound data 20 corresponding to the auscultatory action on the auscultatory point is obtained and extracted. As a matter of course, if no vital sound data 20 corresponding to the auscultatory point 6 was found (which is NO at S3), for example, no vital sound is reproduced from the vital sound player 11 via the reproduction controller 24 (S5).

After the vital sound data 20 is extracted, if the auscultatory pressure 18 and the pressure distribution 19, based on the detected signals 9, are within the appropriate and allowable range, then, if necessary, the sound pressure and the frequency characteristics of the vital sound data 20 can be varied. Also, the appropriate range of the auscultatory pressure 18 and the pressure distribution 19 is predetermined and preset based on the respective auscultatory point 6 and the particular case and is stored in the auscultatory pressure controller 25 and the condition recognitioner 26 respectively.

Here, if the auscultatory pressure 18 at the auscultatory section 14 against the model human body 4 is within the appropriate range (which is YES at S6) and the contact condition between the auscultatory section 14 and the model human body 4 is determined sufficient and appropriate (which is YES at S7), then the extracted vital sound data 20 is reproduced by the vital sound player 11 (S8).

On the other hand, if the auscultatory pressure 18 is either excessive or insufficient and it is not within the appropriate range (which is NO at S6), or if the auscultator pressure 18 is within the appropriate range but the contact condition of the auscultatory section 14 is not sufficient or appropriate (which is YES at S6 and NO at S7), then the auscultatory action is being performed inappropriately, and the vital sound data 20 is reproduced after the sound pressure and the frequency characteristics are changed to perform output control (at S9 or S10)

One example of output control of changing the sound pressure and the frequency characteristics of the vital sound data 20 subject to reproduction will be explained next. If the auscultatory pressure 18 is much lower than the appropriate range, then the reproduced volume at the vital sound player 11 is adjusted and is lower, similar to how the actual stethoscope would perceive lower vital sounds when the auscultatory action is performed inappropriately, thereby intending to create a situation where the trainee 5 is unable to hear the reproduction of the vital sound data 20 clearly. On the other hand, if the auscultatory pressure 18 is much higher than the appropriate range, the auscultatory action performed is found to be inappropriate and the reproduction of the vital sound data 20 is controlled and restricted.

After the vital sound player 11, installed in the ear piece 10 of the stethoscope simulator 2, reproduces the vital sound data 20 via the reproduction controller 24 at S8, the evaluation of the auscultatory action and the result would be output at S11. According to the vital sound data 20 subject to reproduction, the trainee 5 can ascertain the evaluation of his or her auscultatory action through audition. That is, when the stethoscope simulator 2 is used appropriately, the vital sound data 20 is reproduced clearly, which allows the trainee 5 to ascertain whether or not his or her auscultatory technique was satisfactory. On the other hand, if the sounds reproduced based on the vital sound data 20 are unclear, it means that the auscultatory action was incorrectly or inappropriately performed, thereby allowing the trainee 5 to acknowledge his or her insufficient performance. Therefore, the trainee 5 can learn to appropriately locate auscultatory point 6 where the auscultatory section 14 is to be placed on the model surface 7 of the model human body 4 according to the particular case study. In addition to learning appropriate usage of the auscultatory section 14 (or the appropriate manner of applying the auscultatory pressure 18 and making an appropriate contact between the auscultatory section 14 and the model surface 7), repeating and practicing the movement as learned through this process, the trainee 5 can learn the proper auscultatory technique.

Thereafter, whether the auscultatory action is being performed or not is determined at S12. If it is being performed (which is YES at S12), this process goes back to S1 and whether the detected signals 9 from the auscultatory sensor 8 are being transmitted or not is determined. However, if the auscultatory action is not being performed (which is NO at S12), reproduction of the vital sound data is stopped (at S13).

Furthermore, the controller 3 is controlled to adjust the reproduction prerequisites of the vital sound data 20 at the initial stage of the auscultation training as necessary, so that the vital sounds that the medical professional rarely encounters may be heard/experienced virtually based on the vital sound data. Therefore, by using the practice and experience of the various case studies, the medical professional does not have to mentally scramble though the actual diagnosis and can calmly perform an accurate auscultatory action. Here, the reproduction prerequisite can be precisely classified into gender, age, case study, symptoms of the cases (degree of progress), body region, and body types.

As explained above, according to the auscultation training device 1 of the above-embodiment, the trainee 5 can experience and learn the auscultatory action, exactly the same as in the actual auscultatory action, utilizing various case studies and symptoms with a variety of degrees of progress, using the model human body 4. The vital sound data 20 subject to reproduction from the vital sound player 11 of the stethoscope simulator 2 is extremely similar to the actual vital sounds that can be heard while using an actual stethoscope. Therefore, the trainee 5 can experience and learn appropriate auscultatory technique without discomforting feeling. Furthermore, the auscultatory technique of the trainee 5 can be evaluated based on the auscultatory point 6, the auscultatory pressure 18, and the pressure distribution 19. Accordingly, even a beginner can learn the appropriate auscultatory technique with the auscultation training device 1 of this embodiment and can review his or her auscultatory performance.

The preferred embodiments explained above are described only to illustrate this invention and are not intended to limit the scope of this invention. It is understood that modifications of what is described herein may be obvious to persons with ordinary skills in the art without violating the spirit and scope of the claims.

For example, in the above-embodiment, the auscultatory detecting sensor 8 for detecting and determining the auscultatory point 6 and the auscultatory pressure 18 on the model human body 4 with the auscultatory section 14 can be embedded in the model human body 4. However, the locator for determining the auscultatory point 6 and an auscultatory pressure detecting detector for detecting the auscultatory pressure 18 may be substituted for other publicly known devices.

For example, the pressure detecting sensor for detecting the auscultatory pressure 18 may be provided in the auscultatory section 14 of the stethoscope simulator 2. When the trainee 5 performs the auscultatory action on the model human body 4 with this type of auscultatory section 14, detection of the auscultatory action and the auscultatory pressure 18 can be completed simultaneously. Furthermore, the three-dimensional auscultatory point 6 can be located in this embodiment. Therefore, a reference point of the auscultatory section 14 is preset and measuring the degree of variation in X-axis direction, Y-axis direction, and Z-axis direction respectively makes it possible to determine the point of the auscultatory section 14 after the movement. Accordingly, the surface contact type auscultatory sensor 8 does not need to be embedded in order to detect the auscultatory point 6 and the auscultatory pressure 18. As a result, the auscultatory sensor 8 does not need to entirely cover the lower portion of the model surface 7 of the model human body 4, thereby decreasing the cost of manufacturing the auscultatory sensor 8.

In the auscultation training device 1 of the above-described embodiment, the trainee 5 using the stethoscope simulator 2 only can hear the vital sounds based on the vital sound data 20 corresponding to the auscultatory action. However, this invention is not limited to this description. For example, the auscultation training device 1 can be designed for plural listeners, wherein plural stethoscope simulators 2 are provided so that plural instructors and trainees, such as classmates, can hear the vital sound data subject to reproduction corresponding to the auscultatory action of one trainee 5 through the vital sound players 11 installed in the ear pieces 10 of the stethoscope simulators 2 (which are not shown in the figures). Accordingly, plural trainees or instructors can hear the vital sounds based on the vital sound data 20 simultaneously, which facilitates the instructor's teaching and helps to improve the other trainees by monitoring the auscultatory training of the performing trainee in order to improve the auscultatory technique. With plural auscultation devices, as descried above, a general speaker system may be employed instead of employing plural stethoscope simulators 2, so that plural listeners can hear the vital sounds, thereby reducing the cost of manufacturing the system for reproducing the vital sound data 20.

1. An auscultation training device, comprising:
a model human body which is an imitation of a real human body;
a stethoscope simulator which has at least one ear piece fitable in an ear hole of a trainee and an auscultatory section to be placed on said model human body for performing an auscultatory action;
a vital sound data memory system which stores said data based on various vital sounds such as breath sounds and cardiac sounds generated from the human body;
an auscultatory point locator which recognizes the auscultatory action on said model human body with said stethoscope simulator and determines a location of where said auscultatory action took place;
a vital sound data extracting device which extracts said vital sound data from said vital sound memory, said vital sound data corresponds to the determined auscultatory point; and
a vital sound playing device installed in said ear piece of said stethoscope simulator that reproduces said vital sound data extracted from said vital sound memory system.

2. The auscultation training device according to claim 1, further comprising:
an auscultatory pressure detector which detects auscultatory pressure with said auscultatory section at said auscultation point determined by said auscultation point locator; and
a vital sound variation device which based on the detected auscultatory pressure, varies at least one of a sound pressure characteristic and a frequency characteristic of said vital sound data subject to reproduction.

3. The auscultation training device according to claim 1, further comprising:
a condition recognition device which recognizes a contact condition between a surface of the model human body and the auscultatory section during the auscultatory action; and a condition-vital sound variation device which, based on recognized contact condition therebetween, varies at least one of the sound pressure characteristic and the frequency characteristic of said vital sound data subject to reproduction.

4. The auscultation training device according to claim 1, wherein said vital sound memory system stores said vital sound data classified by gender, age, cases, and symptoms of the cases and has a reproduction prerequisite configuring device which presets reproduction prerequisites for the reproduction of said vital sound data.

5. The auscultation training device according to claim 2, wherein said vital sound memory system stores said vital sound data classified by gender, age, cases, and symptoms of the cases and has a reproduction prerequisite configuring device which presets reproduction prerequisites for the reproduction of said vital sound data.

6. The auscultation training device according to claim 3, wherein said vital sound memory system stores said vital sound data classified by gender, age, cases, and symptoms of the cases and has a reproduction prerequisite configuring device which presets reproduction prerequisites for the reproduction of said vital sound data.

7. The auscultation training device according to claim 1, wherein said vital sound data is based on vital sounds which are generated from said real human body.

8. The auscultation training device according to claim 2, wherein said vital sound data is based on vital sounds which are generated from said real human body.

9. The auscultation training device according to claim 3, wherein said vital sound data is based on vital sounds which are generated from said real human body.

10. The auscultation training device according to claim 4, wherein said vital sound data is based on vital sounds which are generated from said real human body.

11. The auscultation training device according to claim 5, wherein said vital sound data is based on vital sounds which are generated from said real human body.

12. The auscultation training device according to claim 6, wherein said vital sound data is based on vital sounds which are generated from said real human body.

13. The auscultation training device according to claim 1, further comprising plural vital sound hearing means which enables at least two persons to hear said vital sound data reproduced therefrom.

14. The auscultation training device according to claim 2, further comprising plural vital sound hearing means which enables at least two persons to hear said vital sound data reproduced therefrom.

15. The auscultation training device according to claim 3, further comprising plural vital sound hearing means which enables at least two persons to hear said vital sound data reproduced therefrom.

16. The auscultation training device according to claim 4, further comprising plural vital sound hearing means which enables at least two persons to hear said vital sound data reproduced therefrom.

17. The auscultation training device according to claim 5, further comprising plural vital sound hearing means which enables at least two persons to hear said vital sound data reproduced therefrom.

18. The auscultation training device according to claim 6, further comprising plural vital sound hearing means which enables at least two persons to hear said vital sound data reproduced therefrom.

19. The auscultation training device according to claim 7, further comprising plural vital sound hearing means which enables at least two persons to hear said vital sound data reproduced therefrom.

20. The auscultation training device according to claim 8, further comprising plural vital sound hearing means which enables at least two persons to hear said vital sound data reproduced therefrom.

21. The auscultation training device according to claim 9, further comprising plural vital sound hearing means which enables at least two persons to hear said vital sound data reproduced therefrom.

22. The auscultation training device according to claim 10, further comprising plural vital sound hearing means which enables at least two persons to hear said vital sound data reproduced therefrom.

23. The auscultation training device according to claim 11, further comprising plural vital sound hearing means which enables at least two persons to hear said vital sound data reproduced therefrom.

24. The auscultation training device according to claim 12, further comprising plural vital sound hearing means which enables at least two persons to hear said vital sound data reproduced therefrom.
